(19) United States
(12) Patent Application Publication
(10) Pub. No.: US 2024/0001290 A1
(43) Pub. Date: Jan. 4, 2024

(54) PROCESS FOR SEPARATING CARBON DIOXIDE FROM A GAS STREAM AND USE

(71) Applicant: PETROLEO BRASILEIRO S.A. - PETROBRAS, Rio de Janeiro (BR)

(72) Inventor: Aline Machado de CASTRO, Rio de Janeiro (BR)

(21) Appl. No.: 18/255,355

(22) PCT Filed: Nov. 22, 2021
(86) PCT No.: PCT/BR2021/050508

§ 371 Date: May 31, 2023

(30) Foreign Application Priority Data
Dec. 2, 2020 (BR) 102020024670-4

(51) Int. Cl. B01D 53/14; B01D 53/18; B01D 53/22

(52) U.S. Cl. CPC B01D 53/1475; B01D 53/1443; B01D 53/1493; B01D 53/18; B01D 53/229; B01D 2252/103; B01D 2256/245

(57) ABSTRACT

The present invention addresses to a CO₂/CH₄ separation process using enzyme carbonic anhydrase, by means of a system with contactor membranes and a vessel containing absorbent liquids that have high salinity, which maintains a specific pH range to promote the formation of carbonate salts, in a way integrated into the CO₂ capture process. Such a process results in a more efficient separation with conversion of CO₂ into products with greater added value or, alternatively, sequestering CO₂ more permanently, thus avoiding its emission into the atmosphere. The present invention is applied to natural gas streams with CO₂ contents, more particularly in offshore oil fields or onshore natural gas processing units, as well as biogas streams.

### FIELD OF THE INVENTION

The present invention addresses to a process for separating carbon dioxide and methane with application in the area of recovery of offshore oil fields and onshore processing of natural gas, aiming at a more efficient separation and that preferentially converts carbon dioxide into products with greater added value or, alternatively, to sequester carbon dioxide more permanently, thus avoiding its emission into the atmosphere.

### DESCRIPTION OF THE STATE OF THE ART

The offshore oil production fields have shown high levels of CO₂ in the gas phase, which needs to be separated from methane, to avoid its emission into the atmosphere and frame the methane for dispatch.

Currently, the processes used on some platforms employ dense gas-gas membranes, which impose high head loss (pressure variation on the feed-permeate sides) and have selectivity limitations, while a lot of methane is lost (CH₄) in the stream of carbon dioxide (CO₂) that is reinjected into the reservoirs. In addition, the reinjection of CO₂ in the gaseous phase represents a stream of high permeability in the rocks, and today the formation of a CO₂ loop between injecting and producing wells has already been observed, tending to increase the concentration of CO₂ in the produced gaseous phase more and more.

Thus, it is of great interest to the Oil and Gas Exploration & Production field that there are technologies that can offer a more efficient separation of CO₂—CH₄ and that, preferably, convert CO₂ to products that generate revenue or, alternatively, sequester CO₂ more permanently.

In this sense, some works have proposed the association of the enzyme carbonic anhydrase (CA) to systems with membranes to accelerate the capture of CO₂. CA acts as a biocatalyst that converts CO₂ into bicarbonate ion (reaction 1) and, depending on the pH (if more alkaline), can lead to obtaining carbonate ion.

CO₂+H₂O⇄HCO₃⁻+H⁺ reaction 1

With an approach in line with this, ILIUTA, I.; ILIUTA, M. C. “Investigation of CO₂ removal by immobilized enzyme carbonic anhydrase in a hollow-fiber membrane bioreactor”, AiChE Journal, v. 63, p. 2996-3007, 2017 evaluated the immobilization of human CA II in hollow fiber membranes composed of nylon, assuming CO₂ dissolved in a buffer solution that was passed through the interior of the membrane as the source of the gas. Bicarbonate concentrations of up to 9 mmol/L were observed, when the CO₂ concentration in solution was around 17 mmol/L.

In turn, CHENG, L. H. et al. “Hollow fiber contained hydrogel-CA membrane contactor for carbon dioxide removal from the enclosed spaces”, Journal of Membrane Science, v. 324, p. 33-43, 2008 proposed a system containing a CA of algal origin immobilized in the hydrogel and poly(acrylic acid-co-acrylamide) layer, covering the polypropylene surface of hollow fiber membranes. The CO₂ concentration was reduced from 0.52% vol at the inlet to 0.09% vol at the outlet of the membrane module.

Recently, XU, Y. et al. “Biocatalytic PVDF composite hollow fiber membranes for CO₂ removal in gas-liquid membrane contactor”, Journal of Membrane Science, v. 572, p. 532-544, 2019 evaluated a gas-liquid contactor system based on poly(vinylidene fluoride) hollow fibers (PVDF) containing CA immobilized on a layer of polydopamine-polyethyleneimine. Pure CO₂ was placed in contact with pure water solution, observing a high CO₂ absorption flow (2.5×10⁻³ mol/m²/s), which was 165% higher than the system without the presence of the enzyme.

CA-coated hollow fiber membranes were also used to remove CO₂ from the blood, for application in patients with acute respiratory diseases as described in ARAZAWA, D. T. et al. “Acidic sweep gas with carbonic anhydrase coated hollow fiber membranes synergistically accelerates CO₂ removal from blood”, Acta Biomaterialia, v. 25, p. 143-149, 2015. O₂ streams containing low concentrations of SO₂ were used for gas carrying, and its recovery in gaseous form after conversion into bicarbonate. Using the integrated system, CO₂ capture increased by up to 109% compared to the control system.

KIM, T. J. et al. “Enzyme Carbonic Anhydrase Accelerated CO₂ Absorption in Membrane Contactor”, Energy Procedia, v. 114, p. 17-24, 2017 developed a system in which PVDF hollow fiber membranes containing a layer of poly(ionic liquids) were used in the material of gas-liquid contactors. The CA enzyme was added to the monoethanolamine solution, in the liquid phase, and the CO₂/N₂ mixture (15%/85%) saturated in water was passed in the gaseous phase. The presence of the enzyme increased the CO₂ capture flow from 0.113 to 0.190 mol/m 2 /h, when compared to the control system.

Teflon-coated polypropylene hollow fiber membranes were used to capture CO₂ from flue gas streams containing N₂, as described in NGUYEN, P. T. et al. “A dense membrane contactor for intensified CO₂ gas/liquid absorption in post-combustion capture”, Journal of Membrane Science, v. 377, p. 261-272, 2011. The liquid phase consisted of monoethanolamine solution, and CO₂ capture rates close to 100% were observed at low gas velocities (0.25-0.50 m/s), subsequently decreasing.

In studies by ATCHARIYAWUT, S. et al. “Separation of CO₂ from CH₄ by using gas-liquid membrane contacting process”, Journal of Membrane Science, v. 304, p. 163-172, 2007 the authors evaluated a process of separation of CO₂ from CH₄ using a contactor system with PVDF membranes, without the presence of the enzyme carbonic anhydrase. As absorber liquid phase, solutions of NaOH, monoethanolamine, or pure water were considered. Gas phase CO₂ removal efficiencies of up to 5% were observed when gas mixtures were fed, and CO₂ absorption flows of up to 3×10⁻³ mol/m²/s were observed, in 2 N NaOH solution, when pure CO₂ was fed into the system.

GHASEM, N. et al. “Effect of PVDF concentration on the morphology and performance of hollow fiber membrane employed as gas-liquid membrane contactor for CO₂ absorption”, Separation and Purification Technology, v. 98, p. 174-185, 2012 also evaluated a PVDF-based hollow fiber membrane system, in which CO₂/CH₄ mixtures were injected into the gas phase, and a 0.5 M NaOH solution was used as an absorbent in the liquid phase of gas-liquid contactors. CO₂ removal rates of around 100% were observed when gas flow rates of the order of 5-10 mL/min were employed using pure gas, and flows of up to 2.5×10⁻³ mol/m²/s were observed when mixtures of 9% CO₂/91% CH₄ were used.

U.S. Pat. No. 9,382,527B2 discloses the use of carbonic anhydrases for the extraction of CO₂ in flue gases, biogas, natural gas or ambient air, through a system with contactor membranes and a vessel containing an enriching liquid. Said patent only proposes the capture of CO₂ in the form of bicarbonate, indicating the dissociation of the ion, and gas recovery, in the vessel coupled to the membrane. However, it does not propose the use of industrial streams such as production water, nor the integrated conversion to stable carbonates of divalent cations, not even the collection of the liquid with CO₂ absorbed in the feed vessel, not forming a loop.

Document US2011223650A1 discloses reactors and processes capable of separating carbon dioxide (CO₂) from a mixed gas using separate modules for absorption and desorption of carbon dioxide. CO₂ extraction can be facilitated using a carbonic anhydrase. Mixed gases are, for example, gases containing CO₂, such as flue gas from coal plants or natural gas, biogas, landfill gas, ambient air, synthetic gas or natural gas or any industrial gas containing carbon dioxide. However, it does not present an integrated system also consisting of the conversion of captured CO₂ into stable forms of carbonates, which add value and efficiency to the process.

WO2013136310A1 discloses a method and system for purifying gas, in particular hydrocarbon gas, such as natural gas, comprising H₂S, mercaptans, CO₂ and other acidic contaminants. Such a document does not describe the use of enzyme carbonic anhydrase and, despite the use of sea water, this is restricted to filtered water only, without the addition of NaOH as a promoter of CO₂ absorption, nor the occurrence of a chemical reaction.

In the study by MENDES, F. B. S. “Remoção de CO₂ de ambientes confinados utilizando contactores com membranas e água do mar sintética como absorvente” (“Removal of CO₂ from confined environments using contactors with membranes and synthetic sea water as an absorbent”), Thesis (Master in Nanotechnology Engineering), UFRJ, p. 101, 2017 discloses a study of a CO₂ removal process from a CO₂/N₂ model mixture using membrane contactors and synthetic sea water as absorbent. Through tests with a commercial module containing polypropylene hollow fibers, it is possible to infer that the absorber liquid flow rate is the process variable that most influences the CO₂ flow. However, synthetic sea water is a 3.5% NaCl solution, which is very different from natural sea water, since the latter is made up of a series of ions, including divalent cations, which can lead to the formation of stable carbonates during CO₂ capture.

As can be seen, some works report the use of gas-liquid contactors with membranes to capture CO₂ in absorbers in the liquid phase. However, studies are still mostly with pure CO₂ streams, and the few that mention mixtures with CH₄, employ very low concentrations of CO₂, which do not represent the current and future scenario of streams arising from the Brazilian pre-salt, nor from natural gas processing, in addition to not reporting the use of the enzyme carbonic anhydrase as a process performance enhancer. The studies that exist today in the state of the art also use pure water for the formulation of absorber liquids, which, in certain places, such as offshore platforms, can represent a major limitation.

In view of this, no document of the state of the art discloses a carbon dioxide and methane separation process such as that of the present invention.

In this way, in order to solve such problems, the present invention was developed, by means of an improved and more efficient process for CO₂/CH₄ mixtures, using not only liquids formulated with pure water, but also low-cost liquids and high availability offshore, such as sea water and oil production water. Because they contain divalent cations in their composition, the use of these liquids further promotes the occurrence of a different reaction during CO₂ capture, with the formation of insoluble carbonates in the liquid phase, which represents a very significant gain on a large scale, as it is a form of monetization of CO₂, as well as a more permanent form of sequestering the gas, thus preventing it from being easily permeated in the reservoir to the producing wells after its reinjection. In addition, the use of production water to capture CO₂ can also contribute to reducing the environmental impact of its possible disposal at sea, acting as a form of liquid treatment.

The present invention presents a cost reduction for the oil production process in fields with high CO₂ content, especially in pre-salt fields, since it allows the permanent capture of gas, avoiding a CO₂ loop between producing-injecting wells, as well as the reduction in the volume of CH₄ reinjected into the CO₂ stream. In addition, the process is operationally safe, as it can also be conducted under low pressure, using pH conditions that are not too severe and toxicity-free biocatalyst.

In view of this, the present invention represents a high environmental advantage, since it promotes the efficient capture of CO₂, avoiding its emission into the atmosphere. The conversion into carbonates also represents a form of environmental contribution, since it consists of more permanently sequestering CO₂. In addition, in the case of using production water, the process leads to a reduction in the salinity of the stream, representing a form of treatment that can reduce the impacts of its possible disposal on the environment.

### BRIEF DESCRIPTION OF THE INVENTION

The present invention addresses to a process for separating CO₂/CH₄ using enzymes carbonic anhydrases, through a system with contactor membranes and a vessel containing absorbent liquids that have high salinity, which maintains a specific pH range to promote the formation of carbonate salts, in a way integrated to the CO₂ capture process. Such a process results in a more efficient separation and that converts CO₂ into products with greater added value or, alternatively, sequesters CO₂ more permanently, thus avoiding its emission into the atmosphere.

The present invention is applied to streams containing CO₂ and CH₄, more particularly streams of natural gas, biogas, with a focus on gaseous streams from pre-salt fields or natural gas processing streams onshore.

### BRIEF DESCRIPTION OF THE DRAWINGS

The present invention will be described in more detail below, with reference to the attached figures which, in a schematic way and not limiting the inventive scope, represent examples of its embodiment. In the drawings, there are:

FIG. 1 illustrating a schematic of the process of the present invention in a laboratory scale, where there are represented: (1) cylinder of high purity CO₂; (2) cylinder of high purity CH₄; (3) box of gas flow rate controller and flow rate, temperature and pressure recorder of all streams; 4) gas mixing box; (5) gas-liquid contactor module; (6) liquid phase vessel, provided with magnetic stifling; (7) liquid phase pH indicator; (8) gas chromatograph;

FIG. 2 illustrating CO₂/CH₄ separation time courses in a gas-liquid contactor with different gas compositions, 10 mM NaOH+0.1 g/L CA as absorber solution, and without pH adjustment. FIG. 2a shows the time course profiles of pH reduction under each condition; FIG. 2b shows the time course profiles of methane purity in the product stream (retentate) at each condition; FIG. 2c shows time course profiles of percent CO₂ removal under each condition;

FIG. 3 illustrating infrared spectra of test samples with NaOH without pH adjustment, where they are represented in (a) condition without addition of CA and (b) condition with addition of CA. The bands show the formation of carbonates and bicarbonates, much more intense in the condition in the presence of the enzyme;

FIG. 4 illustrating time courses of 50% CO₂/50% CH₄ stream separation in a gas-liquid contactor, using sea water+0.1 g/L CA as absorber solution, and without pH adjustment. FIG. 4a shows the pH reduction time course profile; FIG. 4b shows the time course profile of methane purity in the product stream (retentate); FIG. 4c shows the time course profile of percent CO₂ removal; FIG. 4d shows the time course profile of the system selectivity to the gases;

FIG. 5 illustrating time courses of 50% CO₂/50% CH₄ stream separation in a gas-liquid contactor, using sea water+0.1 g/L of CA as absorber solution, and with pH adjustment. FIG. 5a shows the time course profile of pH reduction and added total NaOH concentration; FIG. 5b shows the time course profile of methane purity in the product stream (retentate); FIG. 5c shows the time course profile of percent CO₂ removal; FIG. 5d shows the time course profile of the system selectivity to the gases;

FIG. 6 illustrating infrared spectra of test samples with sea water and pH adjustment;

FIG. 7 illustrating (a) SEM image, (b) with ion detection by EDS, proving the formation of inorganic carbonates in the test with sea water;

FIG. 8 illustrating time courses of 50% CO₂/50% CH₄ stream separation in a gas-liquid contactor, using production water+0.1 g/L CA as absorber solution, and with pH adjustment;

FIG. 8a showing the time course profile of pH reduction and added total NaOH concentration; FIG. 8b showing the time course profile of methane purity in the product stream (retentate); FIG. 8c showing the time course profile of percent CO₂ removal; FIG. 8d showing the time course profile of the system selectivity to the gases;

FIG. 9 illustrating infrared spectra of test samples with production water and pH adjustment;

FIG. 10 illustrating (a) SEM image, (b) with ion detection by EDS, proving the formation of inorganic carbonates in the test with production water;

FIG. 11 illustrating time courses of 50% CO₂/50% CH₄ stream separation in a gas-liquid contactor, using 10 mM NaOH+0.1 g/L CA solution as absorber solution, and with pH adjustment. FIG. 11a shows the time course profile of pH reduction and added total NaOH concentration; FIG. 11b shows the time course profile of methane purity in the product stream (retentate); FIG. 11c shows the time course profile of percent CO₂ removal; FIG. 11d shows the time course profile of the system selectivity to the gases.

### DETAILED DESCRIPTION OF THE INVENTION

The process for separating carbon dioxide from a gaseous stream according to the present invention comprises the following steps:
a. passing a continuous flow gaseous stream containing carbon dioxide and methane, or carbon dioxide, methane and heavier hydrocarbons, or carbon dioxide, methane, heavier hydrocarbons and water through a contactor module containing a membrane or two serial modules;
b. adding to the absorber liquid the enzyme carbonic anhydrase, in pure form, formulation or peptides associated with the enzyme;
c. passing the absorber liquid solution from step (b) through the contactor module through a recirculation system in a loop or in continuous mode, wherein the absorber liquid solution and the gaseous stream operate in a countercurrent direction;
d. adjusting the pH of the absorbent liquid solution to the range of 9.5 to 12 with a NaOH solution to maintain the environment alkaline when the pH is less than 9.

The gaseous stream is a stream of natural gas or biogas, containing from 2% to 70% carbon dioxide.

The absorber liquid can be chosen from industrial water, sea water and synthetic or natural production water, with or without any type of pre-treatment and conditioning. Absorption promoters, amines, hydroxides, inorganic carbonates, among others, can be added to the absorber liquid.

The type of contactor membrane is chosen from poly(tetrafluoroethylene) (PTFE), poly(vinylidene fluoride) (PVDF), poly(dimethyl siloxane) (PDMS), poly(tetrafluoroethylene-co-perfluorinated alkyl vinyl ether) (PFA), polypropylene (PP), ceramics and others.

The gas inlet flow rate can be from 5 to 300 cm³/min/m² membrane.

The gas inlet pressure can be between 0.9 and 70 Bar (90 kPa and 7 MPa).

The liquid flow rate can be between 0.5 and 20 mL/s/m² membrane.

The liquid stream containing absorbed CO₂ must be directed to a second unit, for recovery of CO₂ in gaseous form. And after the CO₂ is recovered in gaseous form, it must be destined for processes of converting this gas into other molecules, or be directed to geological storage.

### EXAMPLES

The examples presented below are intended to illustrate some ways of implementing the invention, as well as to prove the practical feasibility of its application, not constituting any form of limitation of the invention.

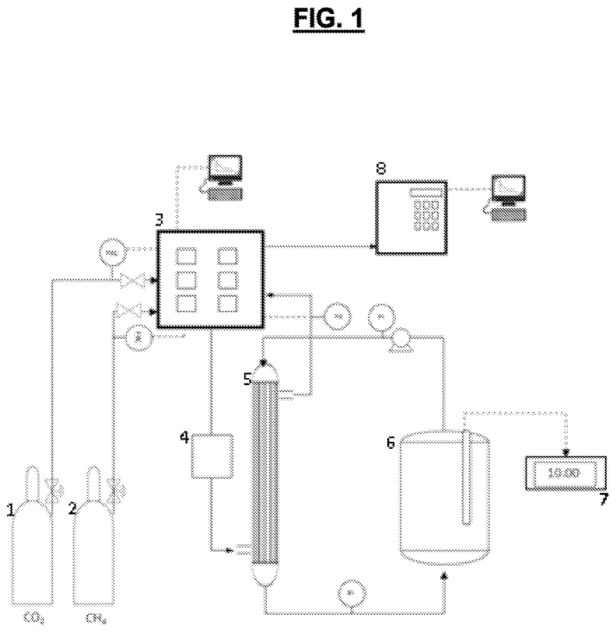

As illustrated in FIG. 1, from the pure gas cylinders, different gas compositions were inserted into the contactor module, after passing through a flow rate control box and a gas mixing box.

The mixed gaseous phase was inserted into the contactor in countercurrent with the liquid phase, coming from a glass vessel provided with stirring (magnetic or mechanical). The liquid passed through the loop system, returning to the vessel after leaving the contactor. The gas, on the other hand, passes in continuous flow, going again to the control box after leaving the contactor, to record its conditions (flow rate, temperature, pressure). This stream of gas leaving the contactor was called retentate. After having its properties recorded, the gaseous phase proceeded for analysis of its composition in a gaseous chromatograph.

### Example 1

### Capture of CO₂ from Mixture with CH₄, using 10 mM NaOH Solution as Absorber

Different gas stream compositions (CO₂/CH₄) were passed continuously through the shell side (outside the fibers) of a contactor module containing hollow hydrophobic fibers of poly(tetrafluoroethylene) (PTFE) with a total area of 1 m² as shown in FIG. 1 (item 5).

The total flow rate of the gaseous stream was maintained at 40 cm³/min (STP). As a liquid phase, a 10 mM NaOH solution containing 0.1 g/L of CA was used, recirculated in a loop at a flow rate of 3.3 mL/s between the glass vessel, as shown in FIG. 1 (item 6), and the inside of the contactor fibers. The absorber liquid solution had an initial pH of about 11.5, which was not adjusted during the process.

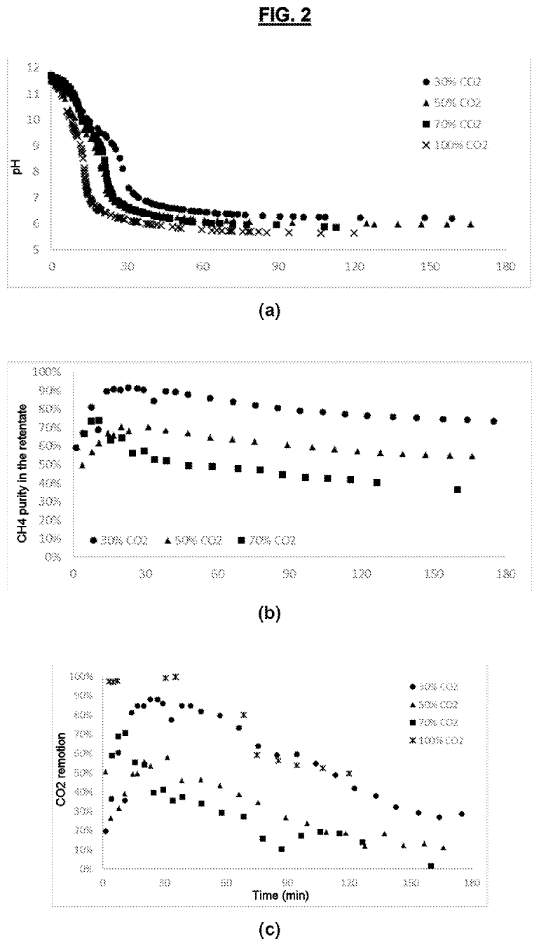

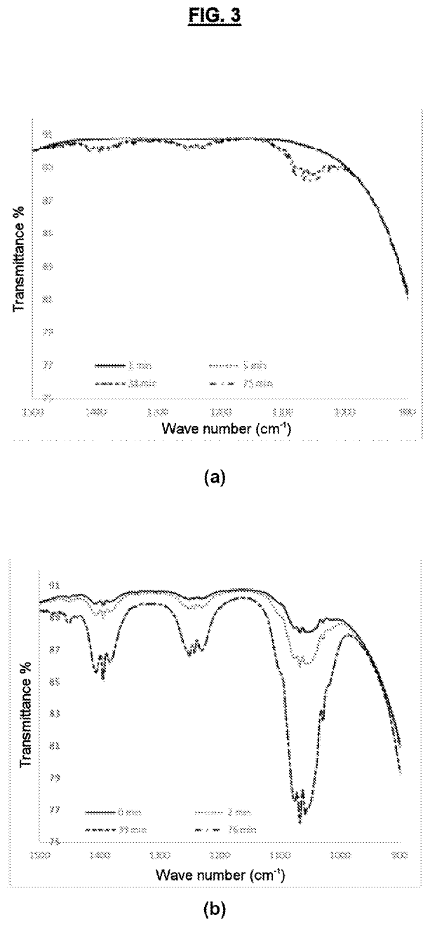

The liquid and gas passed in a countercurrent direction. FIG. 2 shows the results throughout the test, in which the addition of the enzyme to the absorber solution increases its CO₂ capture capacity from 0.48 to 0.56 g/L, with more intense formation of bicarbonate ions, compared to the test control (without enzyme), as shown in FIG. 3.

### Example 2

### Capture of CO₂ from Mixing with CH₄, using Sea Water as Absorber Solution, Without pH Adjustment

A gaseous stream containing 50% CO₂/50% CH₄ was passed continuously through the shell side (outside the fibers) of a contactor module containing hollow hydrophobic PTFE fibers with a total area of 1 m² as shown in FIG. 1 (item 5), at a total flow rate of 40 cm³/min (STP). As a liquid phase, sea water containing 0.1 g/L of CA was used, recirculated in a loop at a flow rate of 3.3 mL/s between the glass vessel, as shown in FIG. 1 (item 6), and the inside the contactor fibers. The absorber liquid solution had an initial pH of about 10, which was not adjusted during the process.

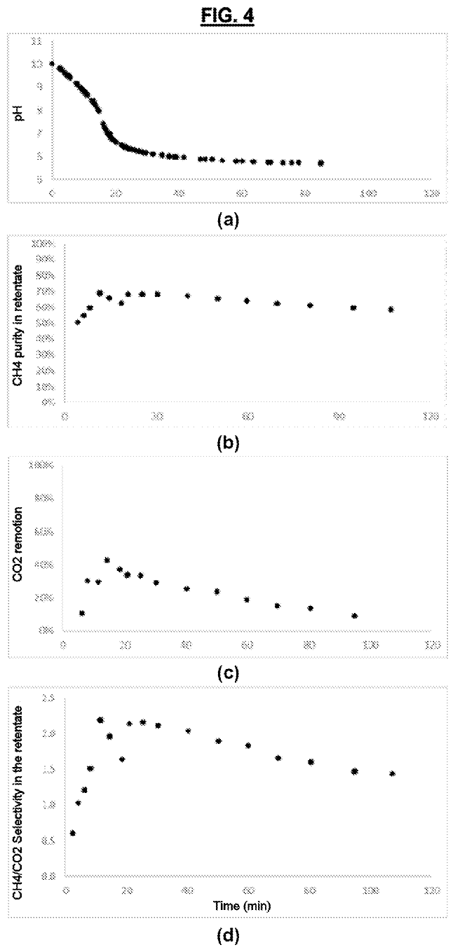

The liquid and gas passed in a countercurrent direction. Sea water was preserved under refrigeration since its collection, and its content of divalent ions is shown in Table 1. FIG. 4 shows the results throughout the test, in which an enrichment of the retentate stream from 50% to 69% CH₄, with CO₂ removal of up to 43% and CH₄/CO₂ selectivity in retentate of up to 2.2.

TABLE 1
Divalent ion composition of the sea water used in the tests.

| Component | Concentration (mg/L) |
|---|---|
| Ca⁺² | 555.6 |
| Mg⁺² | 1369.3 |
| Fe⁺² | 0.035 |

### Example 3

### Capture of CO₂ from Mixing with CH₄, Using Sea Water as Absorber Solution, with pH Adjustment

A gaseous stream containing 50% CO₂/50% CH₄ was passed continuously through the shell side (outside the fibers) of a contactor module containing PTFE hydrophobic hollow fibers with a total area of 1 m², as shown in FIG. 1 (item 5), at a total flow rate of 40 cm³/min (STP). As a liquid phase, sea water containing 0.1 g/L of CA was used, recirculated in a loop at a flow rate of 3.3 mL/s between the glass vessel, as shown in FIG. 1 (item 6), and the inside the contactor fibers. The absorber liquid solution had an initial pH of about 10, which was adjusted intermittently during the process by adding 1 M NaOH solution when the pH reached values below 9, totaling an equivalent addition of 0.1 M NaOH to the liquid phase.

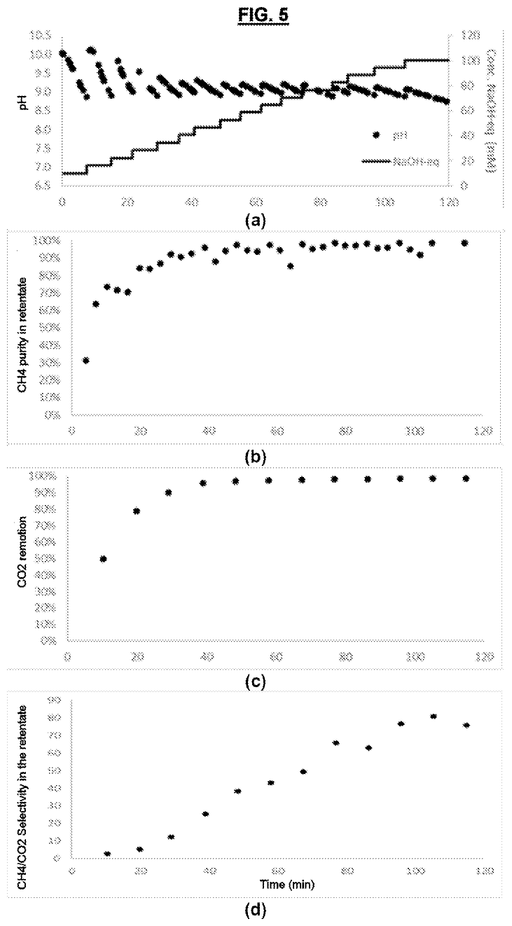

The liquid and gas passed in a countercurrent direction. FIG. 5 shows the results throughout the test, in which the enrichment of the retentate stream from 50% to 98.8% of CH₄ is observed, with CO₂ removal of up to 98.7% and CH₄/CO₂ selectivity in the retentate of up to 81.

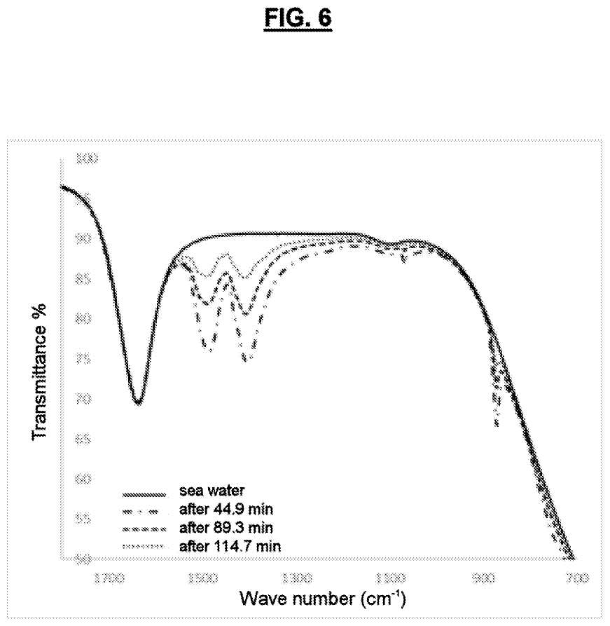

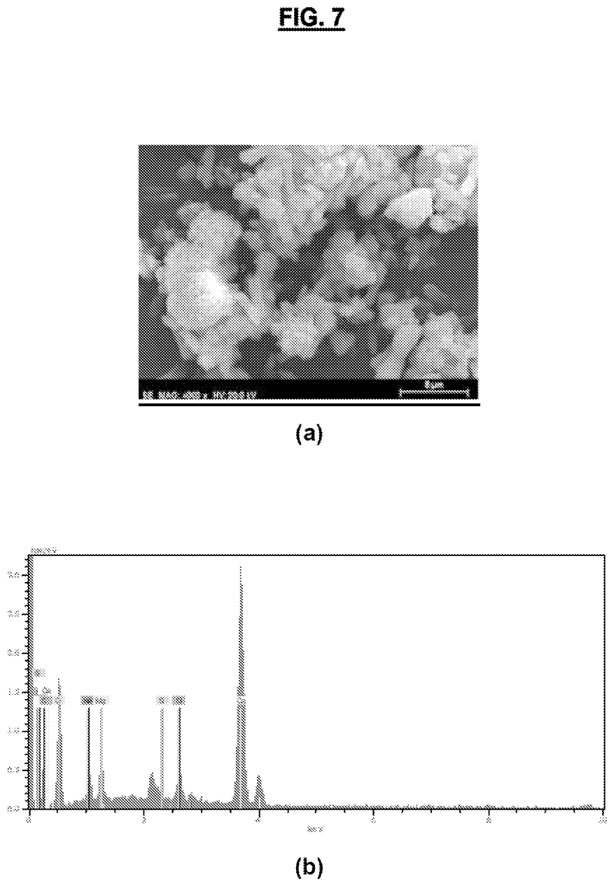

The infrared spectra (FT-IR) indicate the presence of carbonate bands, increasing over the test time as shown in FIG. 6. Scanning electron microscopy (SEM), shown in FIG. 7, proves the presence of crystals of inorganic carbonates, formed by the enzymatic reaction.

Thus, with this condition, it is shown that the use of sea water as an absorber solution, combined with pH control of the solution, to maintain an alkaline environment, is very efficient, leading to the formation of a product that has a value of market or, in the case of reinjection into a reservoir, it may represent a more permanent carbon sequestration.

### Example 4

### Capture of CO₂ From mixing with CH₄, Using Production Water as Absorber Solution, with pH Adjustment

A gaseous stream containing 50% CO₂/50% CH₄ was passed continuously through the shell side (outside the fibers) of a contactor module containing PTFE hollow hydrophobic fibers with a total area of 1 m², as shown in FIG. 1 (item 5), at a total flow rate of 40 cm³/min (STP). As liquid phase, synthetic production water containing 0.1 g/L of CA was used, recirculated in a loop at a flow rate of 3.3 mL/s between the glass vessel, as shown in FIG. 1 (item 6) and the inside of the contactor fibers. The absorber liquid solution had an initial pH of about 9, which was adjusted intermittently during the process by adding 1 M NaOH solution when the pH reached values below 8.5-9, totaling an equivalent addition of 0.09 M NaOH to the liquid phase.

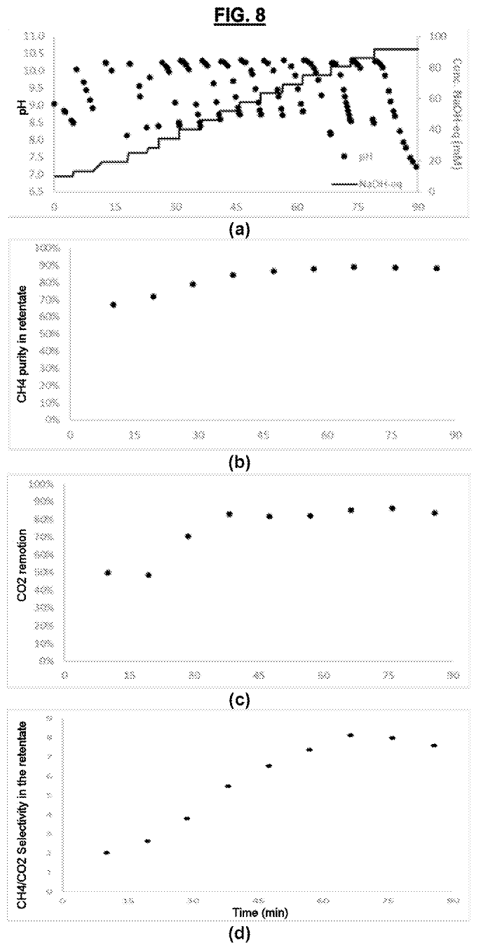

The liquid and gas passed in a countercurrent direction. Table 2 shows the content of divalent cations in the used production water. FIG. 8 shows the results throughout the test, in which an enrichment of the retentate stream from 50% to 89.1% of CH₄ was observed, with CO₂ removal of up to 86.2% and CH₄/CO₂ selectivity in the retentate of up to 8.1.

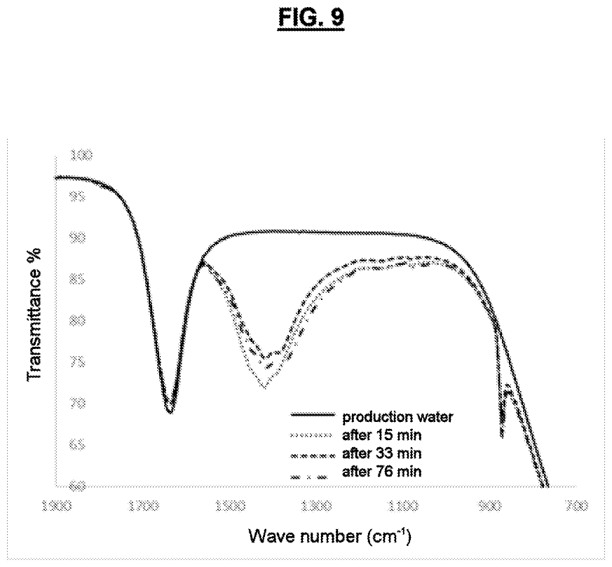

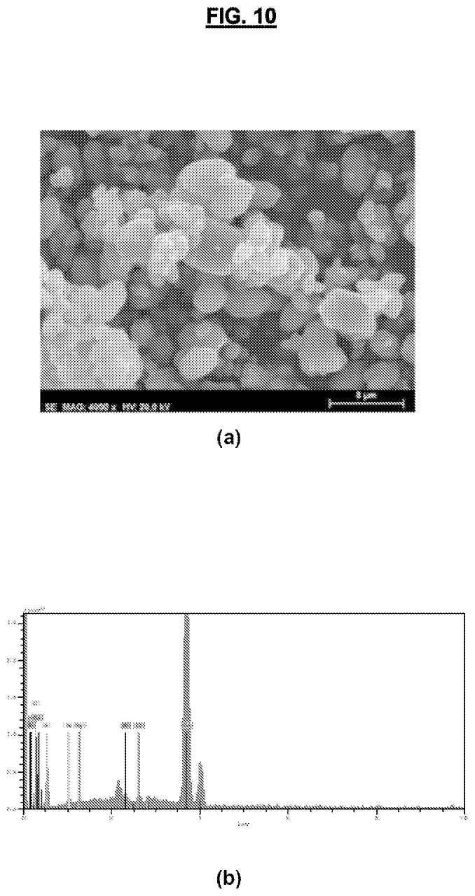

The infrared spectra indicate the presence of carbonate bands, increasing over the test time, as shown in FIG. 9. SEM analysis, shown in FIG. 10, prove the presence of inorganic carbonate crystals, formed by enzymatic reaction. Furthermore, it was quantified that the salinity of the production water was reduced from 68.9 to 62.8 g/L with the test, also indicating that the process promotes a partial treatment of this stream, which is an effluent from the oil and gas sector.

Therefore, the use of an effluent from the E&P area, combined with pH control of the solution, also proved to be technically feasible for the CO₂ capture process.

TABLE 2
Divalent ion composition of the production water used in the tests.

| Ion | Concentration (mg/L) |
|---|---|
| Ca²⁺ | 2530 |
| Mg²⁺ | 530 |
| Sr²⁺ | 7 |

### Example 5

### Capture of CO₂ from Mixture with CH₄, using NaOH Solution as Absorber Solution, with pH Adjustment

A gaseous stream containing 50% CO₂/50% CH₄ was passed continuously through the shell side (outside the fibers) of a contactor module containing hollow hydrophobic PTFE fibers with a total area of 1 m², as shown in FIG. 1 (item 5), at a total flow rate of 40 cm³/min (STP). As a liquid phase, a 10 mM NaOH solution containing 0.1 g/L of CA was used, recirculated in a loop at a flow rate of 3.3 mL/s between the glass vessel, as shown in FIG. 1 (item 6), and the inside of the contactor fibers. The absorber liquid solution had an initial pH of about 11.5, which was adjusted intermittently during the process by adding 1 M NaOH solution when the pH reached values below 9, totaling an equivalent addition of 0.1 M NaOH to the phase liquid.

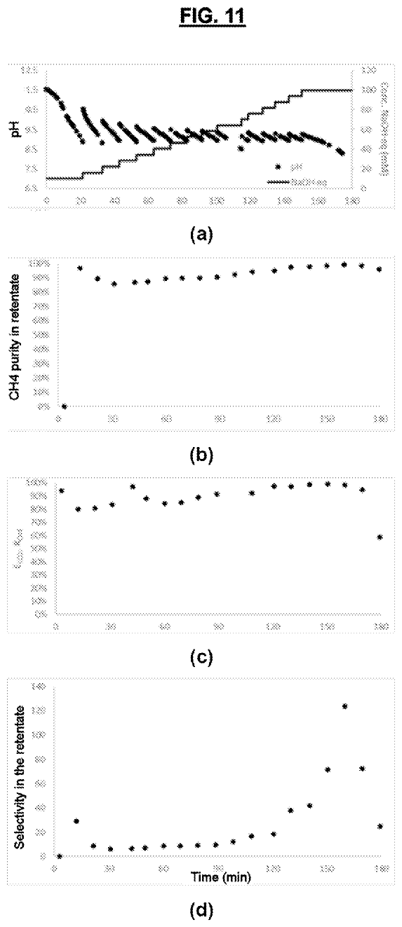

The liquid and gas passed in a countercurrent direction. FIG. 11 shows the results throughout the test, in which an enrichment of the retentate stream from 50% to 99.2% of CH₄ was observed, with CO₂ removal of up to 99.2% and CH₄/CO₂ selectivity in the retentate up to 124 times.

Therefore, this example demonstrates a strategy for efficiently using NaOH solution for the separation of CO₂/CH₄, under appropriate conditions for the enzyme to act, since with the batch fed with NaOH solution (for the intermittent control of pH) having very high pH conditions in the liquid is avoided, which could cause the loss of CA activity.

It should be noted that, although the present invention has been described in relation to the attached drawings, it may undergo modifications and adaptations by technicians skilled on the subject, depending on the specific situation, but provided that within the inventive scope defined herein.

1. A process for separation of carbon dioxide from a gaseous stream comprising:
a. passing a continuous flow gaseous stream containing carbon dioxide and methane through a contactor module containing membranes;
b. adding the enzyme carbonic anhydrase to the absorber liquid;
c. passing the absorber liquid solution from step (b) through the contactor module by a loop recirculation system, wherein the absorber liquid solution and the gaseous stream operate in a countercurrent direction; and
d. adjusting the pH of the absorber liquid solution with a NaOH solution, to maintain the environment alkaline when the pH is less than 9.

2. The process of claim 1, wherein the gaseous stream is natural gas or biogas.

3. The process of claim 1, wherein the gaseous stream contains comprises between 2% and 70% of carbon dioxide.

4. The process of claim 1, wherein the contactor module comprises two contactor modules in series.

5. The process of claim 1, wherein the absorber liquid is industrial water, sea water or production water.

6. The process of claim 5, wherein the production water is synthetic or natural.

7. The process of claim 1, wherein the absorber liquid is used with or without pre-treatment and conditioning, with or without the addition of a promoter, amine, hydroxide or inorganic carbonate.

8. The process of claim 1, wherein the absorber liquid solution in step (c) passes in continuous mode.

9. The process of claim 1, wherein the pH is adjusted to the range of 9.5 to 12.

10. The process of claim 1, wherein the membrane of the contactor is chosen from ptfe, pvdf, pdms, pfa, pp or ceramic.

11. The process of claim 1, further comprising directing the liquid stream containing absorbed CO₂ to a second unity for recovery of CO₂ in gaseous form.

12. The process of claim 11, wherein the CO₂ recovered in gaseous form is destined to conversion processes of this gas into other molecules, or is directed to geological storage.

13. (canceled)
